(19) United States
(12) Patent Application Publication
(10) Pub. No.: US 2026/0288426 A1
(43) Pub. Date: Sep. 24, 2026

(54) UNIVERSAL GRAPHICAL USER INTERFACE AND METHODS FOR USE THEREWITH

(71) Applicant: Sirenix ApS, Copenhagen (DK)

(72) Inventors: Bjarke Elias Clauson-Kaas Orrild, Horsens (DK); Tor Esa Vestergaard, Capital Region (DK)

(73) Assignee: Sirenix ApS, Copenhagen (DK)

(21) Appl. No.: 19/490,190

(22) PCT Filed: May 28, 2024
(86) PCT No.: PCT/US2024/031211

§ 371 Date: Dec. 4, 2025

Related U.S. Application Data
(60) Provisional application No. 63/508,153, filed on Jun. 14, 2023.
(60) Provisional application No. 63/508,141, filed on Jun. 14, 2023.

(51) Int. Cl. G06F 8/34

(52) U.S. Cl. CPC G06F 8/34

(57) ABSTRACT

A universal graphical user interface (GUI) library for use with an application development platform includes: a universal GUI core that is configurable for a plurality of client device types and a plurality of different programming languages, wherein the universal GUI core implements immediate mode GUI operations of an immediate mode GUI; and a retained mode layer that is configured to implement retained mode GUI operations via calls to the immediate mode GUI operations of the universal GUI core.

### TECHNICAL FIELD

The present disclosure relates to graphical user interfaces used in the selection, presentation and display of media content via computing devices.

### BRIEF DESCRIPTION OF THE SEVERAL VIEWS OF THE DRAWINGS

FIG. 1A presents a block diagram representation of a system in accordance with an example of the present disclosure.

FIG. 1B presents a block diagram representation of a GUI-based application (App) in accordance with an example of the present disclosure.

FIG. 1C presents a block diagram representation of GUI-bases transpiling in accordance with an example of the present disclosure.

FIG. 1D presents a block diagram representation of a bitwise processing in accordance with an example of the present disclosure.

FIGS. 2A through 2E are schematic block diagrams of examples of computing entities that are part of an improved computer technology.

FIGS. 2F through 2L are schematic block diagrams of examples of computing devices that form at least a portion of a computing entity.

FIG. 2M is a schematic block diagram of an example of a database.

FIG. 3A presents a flowchart representation of an example method.

FIG. 3B presents a flowchart representation of an example method.

### DETAILED DESCRIPTION

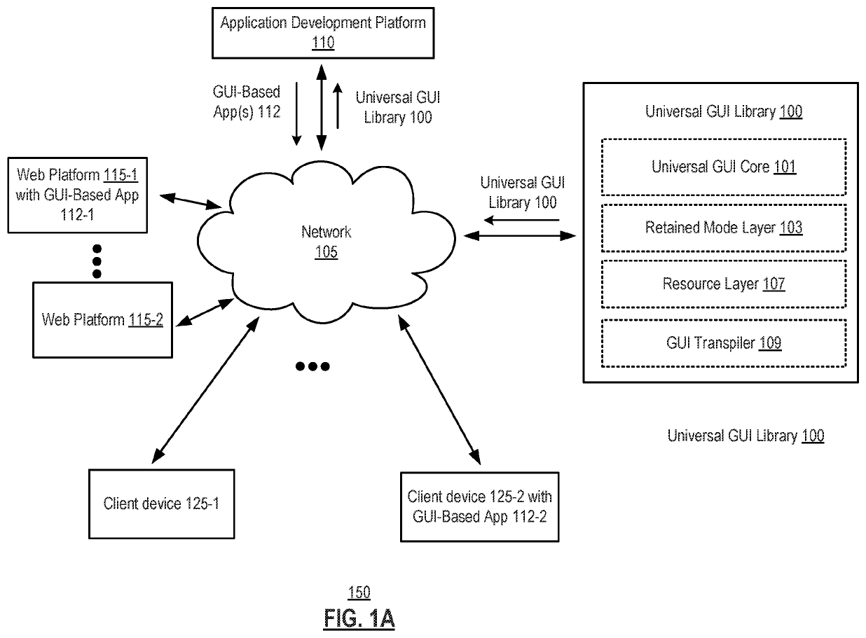

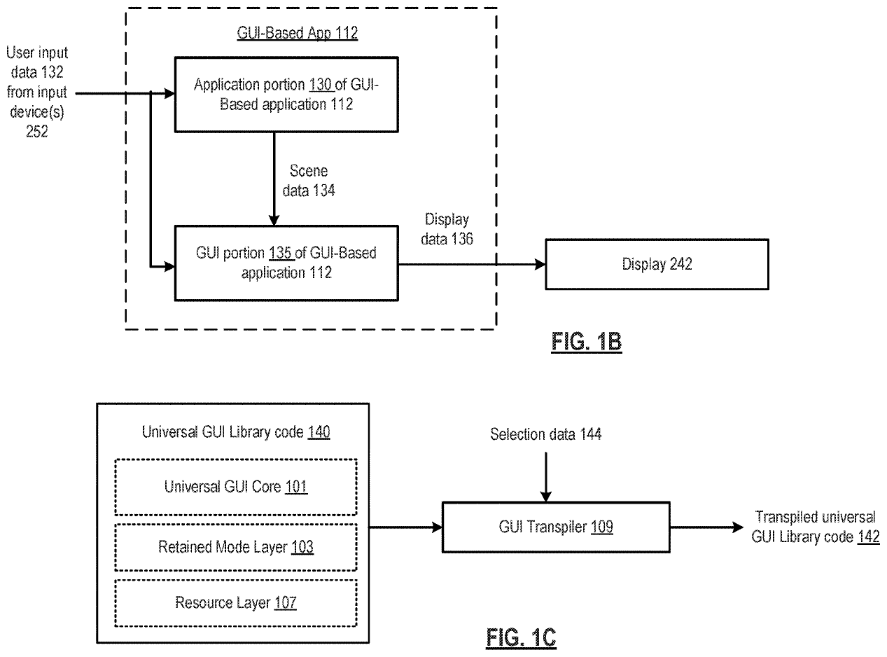

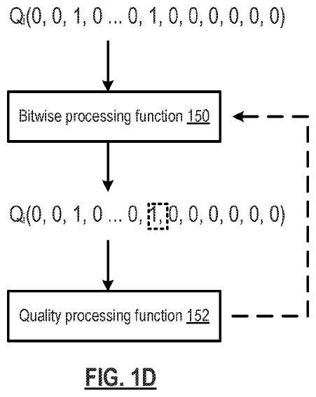

FIG. 1A presents a block diagram representation of a system in accordance with an example of the present disclosure. In particular, an application development platform 110 is presented that communicates via network 105. The network 105 can be the Internet or other wide area or local area network, either wired or wireless and either public or private.

In various examples, the application development platform 110 receives a universal graphical user interface (GUI) library 100 which is used to develop one or more GUI-based application(s) (apps). The apps can include, for example:
Desktop applications: These are software applications that are installed on a user's computer and provide a graphical user interface for the user to interact with.
Web applications: These are software applications that are accessed through a web browser and provide a graphical user interface for the user to interact with.
Mobile applications: These are software applications that are designed specifically for mobile devices, such as smartphones and tablets, and provide a graphical user interface for the user to interact with.
Gaming applications: These are software applications that are designed for gaming purposes and provide a graphical user interface for the user to interact with.
Multimedia applications: These are software applications that are designed for multimedia purposes, such as video editing, music production, and graphic design, and provide a graphical user interface for the user to interact with.
Productivity applications: These are software applications that are designed to help users be more productive, such as word processors, spreadsheets, and presentation software, and provide a graphical user interface for the user to interact with.
Educational applications: These are software applications that are designed to provide educational content and activities, such as language learning apps, math games, and science simulations, and provide a graphical user interface for the user to interact with.

In some examples, a GUI-based app 112-1 is executed by a web platform 115-1 that operates, for example, via a browser or other app of a client device 125-1. In other examples, a GUI-based app 112-2 operates via client device 125-2 with or without interaction with one or more other web platforms 115-2.

In various examples, the client devices 125 can be personal computers, laptops, tablets, smart phones, smart watches and/or other computing entities. The web platforms 115 can be implemented via webservers, cloud network devices and/or other computing entities. The universal GUI library 100 can be stored on, or implemented via, one or more webservers, cloud network devices and/or other computing entities.

In various examples, universal GUI library 100 includes a universal GUI core 101 that provides the base, fundamental and/or minimum set of features needed to create a UI. The universal GUI core 101 implements the glue that holds the rest of the features together, as well as the fundamental pattern of working with the universal GUI library 100, which is to: 1) receive GUI input data such as key presses, mouse/touch positions, time, etc. ; 2) run the GUI code to tell the GUI what to draw; 3) receive a list of graphics commands; and then 4) execute these commands to produce output data for display. As part of the “universal” GUI library 100, the universal GUI core 101 is easily configurable for a plurality of client devices and/or device types, custom engines and computing environments and a plurality of different programming languages.

In various examples, universal GUI core 101 contains a combination of one or more of the following features:
A layout function that, for example, computes the size and position of all elements based on parameters are specified via the user of the application development platform 110. In various examples, the layout specification can be thought of as a refined and improved Flexbox (Flexible Box) model or layout tool or other layout specification of size, position and/or relationships thereof. In a specific example, the layout function is a layout tool that can facilitate the design of dynamic and responsive web layouts that adjust to different screen sizes and devices. The layout function can, for example, arrange elements in rows or columns and provide flexibility in distributing space among elements in a container.
A shapes system that, for example, facilitates creating and animating simple to complex shapes and applying graphical effects to them. Examples include a circle with a bevel, a curved line with variable width and drop shadow, boxes with rounded corners, combinations of the above such as a box with a circle slice “subtracted”, and so on.
A text system that, for example, facilitates parsing, layouting and/or rendering text accurately, with correct kerning, support for different layout directions and support for languages with standard Roman, Greek, Cyrillic, Hebrew alphabets, etc. and/or complex glyphs like Arabic, Chinese, Japanese, etc. In various examples, this text system includes a text rendering function that operates via signed distance field (SDF) data that is generated on a pixel basis based on vector data. In various examples, vector data corresponding to glyphs can be rendered on a rectangular area such as a square, based on an SDF texture. In various examples, the text rendering can be performed via a GPU or other processor after parsing and layouting and generation of meshes has been performed in the shader, calculating the colors of the pixels on screen based on data that has been loaded into GPU memory. In various examples, instead of loading pre-computed data such as rasterized font glyph images or SDF field textures, the text rendering function simply loads the pure font vector data (in the form of, for example, a set of mathematically defined curves that make up the lines that form each individual character) onto the GPU. At compute-time in the shader on the GPU itself, and on a per pixel-basis the shader can, in various examples, infer an SDF from the curve data in order to generate effects such as soft drop shadows, inner shadows, strokes, glows, etc. (and not based on pre-computed data such as rasterized font glyph images or SDF field textures)
A styling system that, for example, facilitates creating styles and animations such as Cascading Style Sheets (CSS) or other formats. This can include elements such as layouting specifications, background colors, rounded corners for boxes, mouseover animations, effects like glow, and so on and so forth. In essence, styles are a compact and handy way of specifying how the layouting, text and shape systems come together to create various graphical elements, and then adding the concept of animations between various properties on top of that.
Resource loading, parsing and handling for necessary resource types like fonts, images, possibly styles, etc. and/or
Shaders that, for example, facilitate rendering things subject to the requirements of the user, IE, direct font curve rendering on the GPU, SDF/MSDF rendering, etc. In various examples, the shaders may also render vector graphics data utilizing signed distance fields (SDFs) that are not pre-computed.

It should be noted that while the layout function may be represented as part of the universal GUI core 101, it could be considered its own layer that operates in conjunction with a universal GUI core 101 that lacks this functionality. Similarly, the other features presented above could likewise be considered to be included within or external to the universal GUI core 101.

Unlike traditional GUIs that operate via massive call stacks and layer upon layer of dependencies, in various examples, the universal GUI library 100 operates via “zero dependencies” i.e., without dependency to any other GUI library or without calls/references to external routines. In some examples, the universal GUI library 100 operates solely via the universal GUI core 101. In these examples, the universal GUI core 101 implements solutions to every problem related to GUI creation and rendering. In other examples, these solutions are grouped into a core and several layers around it, with each layer adding on more abstraction, while the core is intended to be the purest possible “simple/minimum viable” system that is still as powerful as possible within the scope of that simplicity, and which furthermore is written to be as performant as possible. In the example shown, the universal GUI library 100 also includes other elements such as a retained mode layer 103, and/or a resource layer 107. In various examples one or more of these elements are also configurable for a plurality of client device types and a plurality of different programming languages.

The GUI transpiler 109 can assist in this process to convert the native programming language of the universal GUI library 100 into the programming language of the expected device type and/or processing environment. In various examples, the GUI transpiler 109 enables use of the other elements of the universal GUI library 100 as broadly as possible and on as many platforms as possible. Given the nature of the universal GUI library 100, using only basic computing features universal to all languages, and the fact that is has no dependencies on other libraries, it becomes feasible to transpile the universal GUI code to other programming languages, for other processing environments and/or for other devices and/or platforms.

In various examples, the GUI transpiler 109 is written specially for the universal GUI library 100, and specifically to easily transpile the code of universal GUI core 101, along with the code of the retained mode layer 103 and the resource layer 107 (when these layers are included in a particular use case). In some examples, the GUI transpiler 109 doesn't need to merely be a transpiler—it can also be a transformer and code generator, automating the writing of some code (systems like layouting and styling involve a lot of repeating code variants, like width and height calculations being mirrors of each other, that can be automatically written by the transpiler). The GUI transpiler 109 can also be configured to programmatically make modifications to universal GUI library 100 based on the target platform/language and/or environment. There might be a difference between C++ universal GUI library 100 for app development and C++ universal GUI library 100 for Unreal, between C #universal GUI library 100 for web and C #universal GUI library 100 for Unity. To provide a proper integrated experience, the Unreal variant can, for example, make use of Unreal's built-in data and resource types, making it feel natural to use in Unreal, as if it was built for it to begin with.

In various examples, the retained mode layer 103 is added on top of the immediate mode of the universal GUI core 101. The retained mode layer 103 is, in most senses, a classical retained mode UI, in terms of how developers interact with it. It operates via retained mode graphical elements, which can contain child elements. Elements can be bound/linked to data, for display and possible mutation based on user input. These retained mode elements can be retained across frames and have a lifetime (after which they, for example, expire). Furthermore, the retained mode layer 103 can call down into the immediate mode code of the universal GUI core 101, for example, as a way of specifying the structure of the universal GUI core 101 that is supposed to be run. The resource layer 107, when included, provides the retained mode layer 103 the ability to load resource files that define the retained mode element structure(s) of the GUI. In various examples, these resource files can be in the style of XML, HTML, or other format, etc. In various examples, the retained mode layer 103 operates as a system that spreads out the overhead of creating a GUI by caching the required state across frames so the layer doesn't need to recalculate and rebuild layouting information, mesh data, and so on, every frame. When something changes, it can calculate only the difference between the old and new state, which is computationally cheaper than recalculating everything. The retained mode layer 103 can be fed events such as mouse clicks as they happen and can mutate based on these inputs. When nothing happens, the retained mode layer 103 is “free” to do nothing. In order to not recalculate everything, the retained mode layer 103 operates via the concept of “change boundaries”—a change might affect A, but not B or C, so the layer only needs to recalculate the cached data for A.

In various examples, the retained mode layer 103 can contain enough information to determine where these “change boundaries” are—and only be fed events as they happen—otherwise the retained mode layer 103 can (and need not) execute anything. Additionally, the retained mode layer 103 can mutate part of its state based on those events and keep the results to be served up in future frames. The immediate mode code of the universal GUI core 101 permits the GUI to run at will—without the retained mode layer 103 executing in every frame. The overall result is a system that is fast and efficient enough to be run fully in intermediate mode, computing and recalculating absolutely everything every frame—being performance competitive or superior to most retained mode systems while doing this. In this fashion, the improved system gains the same proportional increase in performance that other retained mode systems gain by using the caching of previously generated data. Other systems are slow as a base and use caching to become fast so long as very little changes. The improved system is fast as a base, and can use caching to become even faster so long as very little changes.

This allows these two layers to interweave seamlessly by their nature alone. Regular immediate mode code can make use of retained mode elements, for example, by simply saying, “now draw yourself here”—there is no difference in results to the pure immediate mode code than calling any other arbitrary function that executes the immediate mode code. And further, the inverse is also true—the retained mode layer 103 can itself invoke immediate mode code of the universal GUI core 101 anywhere and at any time—providing the best of both such layers. This also allows the universal GUI library 100 to achieve the performance improvements of being “fully retained” while avoiding the traditional design costs and limitations of being fully retained. Furthermore, this allows developers to create complicated GUIs with good performance on even the most anemic hardware.

Consider the following example where the universal library 100 is presented for use with an application development platform 110 having at least one processor and a non-transitory computer readable memory, the universal GUI library 100 comprising: a universal GUI core 101 that is configurable for a plurality of client device types and a plurality of different programming languages, wherein the universal GUI core implements immediate mode GUI operations of an immediate mode GUI; and a retained mode layer 103 that is configured to implement retained mode GUI operations via calls to the immediate mode GUI operations of the universal GUI core 101.

In addition or in the alternative to any of the foregoing, the universal GUI core and the retained mode layer each operate without dependency on another GUI library.

In addition or in the alternative to any of the foregoing, the universal GUI library further includes a resource layer configured to load retained mode structure to the retained mode layer.

In addition or in the alternative to any of the foregoing, the resource layer, the universal GUI core and the retained mode layer each operate without dependency on any other GUI library.

In addition or in the alternative to any of the foregoing, the plurality of different device types include a plurality of mobile device types and a plurality of non-mobile device types.

In addition or in the alternative to any of the foregoing, the universal GUI core includes a layout function that stores a quality vector for each corresponding layout node of a plurality of layout nodes, the quality vector including binary bits that each correspond to one of a plurality of layout qualities and indicate whether or not the one of the plurality of layout qualities is specified for the corresponding layout node; wherein the layout function operates via a bitwise processing function to identify a proper subset of the plurality of layout qualities that is specified for the corresponding layout node.

In addition or in the alternative to any of the foregoing, the universal GUI core includes a text rendering function that operates via signed distance field data that is generated on a pixel basis based on vector data.

In addition or in the alternative to any of the foregoing, the universal GUI core includes a graphics rendering function that operates via signed distance field data that is not pre-computed and is generated via vector graphics data.

In addition or in the alternative to any of the foregoing, the universal GUI library further includes a GUI transpiler configured to transpile universal GUI library code from a native coding language to an alternative coding language in response to selection of a corresponding one of the plurality of device types.

In addition or in the alternative to any of the foregoing, the universal GUI library further includes a GUI transpiler configured to transpile universal GUI library code from a native coding language to an alternative coding language in response to selection of a processing environment.

Consider the following example where the universal library 100 is presented for use with an application development platform 110 having at least one processor and a non-transitory computer readable memory, the universal GUI library 100 comprising: a universal GUI core that is configurable for a plurality of client device types and a plurality of different programming languages; and a text rendering function that operates via signed distance field data that is generated on a pixel basis based on vector data.

In addition or in the alternative to any of the foregoing, the universal GUI library further includes: a retained mode layer that is configured to implement retained mode GUI operations via calls to the immediate mode GUI operations of the universal GUI core,
In addition or in the alternative to any of the foregoing, the universal GUI core and the retained mode layer each operate without dependency on another GUI library.

In addition or in the alternative to any of the foregoing, the universal GUI library further includes a resource layer configured to load retained mode structure to the retained mode layer.

In addition or in the alternative to any of the foregoing, the resource layer, the universal GUI core and the retained mode layer each operate without dependency on any other GUI library.

In addition or in the alternative to any of the foregoing, the plurality of different device types include a plurality of mobile device types and a plurality of non-mobile device types.

In addition or in the alternative to any of the foregoing, the universal GUI core includes a layout function that stores a quality vector for each corresponding layout node of a plurality of layout nodes, the quality vector including binary bits that each correspond to one of a plurality of layout qualities and indicate whether or not the one of the plurality of layout qualities is specified for the corresponding layout node; wherein the layout function operates via a bitwise processing function to identify a proper subset of the plurality of layout qualities that is specified for the corresponding layout node.

In addition or in the alternative to any of the foregoing, the universal GUI core includes a graphics rendering function that operates via signed distance field data that is not pre-computed and is generated via vector graphics data.

In addition or in the alternative to any of the foregoing, the universal GUI library further includes a GUI transpiler configured to transpile universal GUI library code from a native coding language to an alternative coding language in response to selection of a corresponding one of the plurality of device types.

In addition or in the alternative to any of the foregoing, the universal GUI library further includes a GUI transpiler configured to transpile universal GUI library code from a native coding language to an alternative coding language in response to selection of a processing environment.

It should be noted that while the GUI transpiler 109 is shown as internal to the universal GUI library 100, this element can be implemented either external or internal to the universal GUI library 100. Furthermore, the universal GUI library 100 can be implemented in a cloud computing configuration with the one or more of its elements within the cloud. Additional examples, including different combinations, functions and features are described in conjunction with the other figures and the description that follows.

FIG. 1B presents a block diagram representation of a GUI-based application (App) in accordance with an example of the present disclosure. In the example shown, a GUI-based app 112 includes an application portion 130 and a GUI portion 135 that operates, for example, based on a transpiled version of one or more layers of the universal GUI library 100. User input data in the form of mouse, clicks, screen touches, etc. are received from one or more input devices 252. The application portion 130 generates scene data 134 scenes) that is used by GUI portion 135 to generate the display data 136 (e.g., frames) for display by a display device 242 of a client device 125.

FIG. 1C presents a block diagram representation of GUI-bases transpiling in accordance with an example of the present disclosure. In the example shown, universal GUI library code 140 corresponding to the universal GUI core 101, the retained mode layer 103 and/or the resource layer 107 is transpiled by a GUI transpiler 109 which is specific to the universal GUI library code 140. The GUI transpiler 109 operates based on selection data 144 to transpile the universal GUI library code 140 from a base language such as C #into the transpiled universal library code 142.

The selection data 144 can specify a target programing language, a target client device and/or other properties of a target processing environment where the transpiled universal library code 142 will ultimately run natively or as natively as possible. In various examples, the transpiler 109 can be executed by the application development platform 110 or other computing entity. In this fashion, the code components of the universal GUI library 100 can be transpiled for developers creating applications in languages such as C, C++, C #, Rust, JavaScript, Python, (with or without a native backend in another language such as C or C++), processing environments such as Unreal, Unity, Monogame, Web Presentation Foundation (WPF), WebAssembly, and/or for client device types such as mobile (e.g., Android, IOS, etc.) and/or desktop, etc.

FIG. 1D presents a block diagram representation of a bitwise processing in accordance with an example of the present disclosure. As previously discussed, the universal GUI core can include a layout function. This layout function can operate via a bitwise processing function to identify a proper subset of the plurality of layout qualities (i.e., some but not all) that indicate the value types specified for the corresponding layout node.

Consider an example where the layout function stores a quality vector Q (e.g., a bit field such as a matrix or other vector) for each corresponding layout node of a plurality of layout nodes, the quality vector including binary bits that each correspond to one of a plurality of layout qualities and that each indicate whether or not the one of the plurality of layout qualities is specified for the corresponding layout node. In the example shown, the quality vector Qᵢ corresponds to the ith node of a layout includes a binary value for each possible layout quality indicating which of these layout qualities are (and are not) specified for this node. In particular, if a particular quality is specified for the ith node, the corresponding binary value is assigned a “1”—otherwise a value of “0” is stored indicating that this particular quality is not specified.

In operation, a bitwise processing function 150 treats the quality vector Qᵢ as a binary number and uses bitwise mathematics to identify the least significant bit (the 7^{th} bit from the right in this case) having a value of “1”. The quality processing function can 152 then check the specification(s) for the corresponding quality value (corresponding to the 7^{th} bit)—skipping over the prior 6 qualities—without the need to check the specification for these qualities. In various examples, the bitwise processing function 150 operates by treating the binary digits of the quality vector Qᵢ as a de Bruijn sequence and deterministically identifies the lowest-order bit having a value of 1. This bit position can then be mapped to its corresponding layout quality and the Quality processing function can then check the corresponding specifications. This process can be repeated in an iterative fashion by eliminating the 7 lowest-order bits and continuing on to identify the position (and corresponding quality) of the next-most-least significant bit having a “1”, and so on until specifications for all of the qualities having a corresponding “1” in the quality vector have been checked. This improves the technology of GUI's by only checking the specifications of those qualities that are specified for each layout node—and not checking the others.

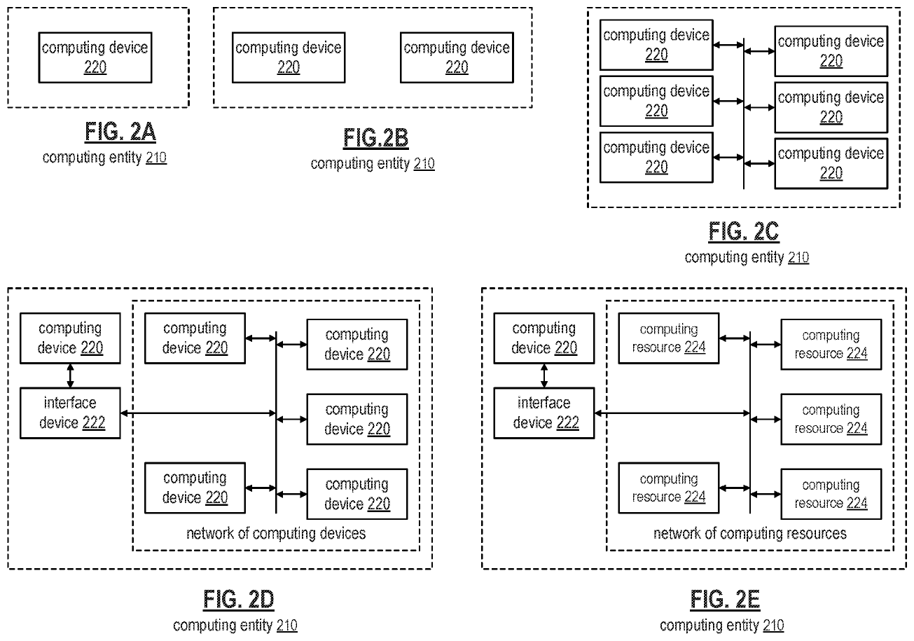

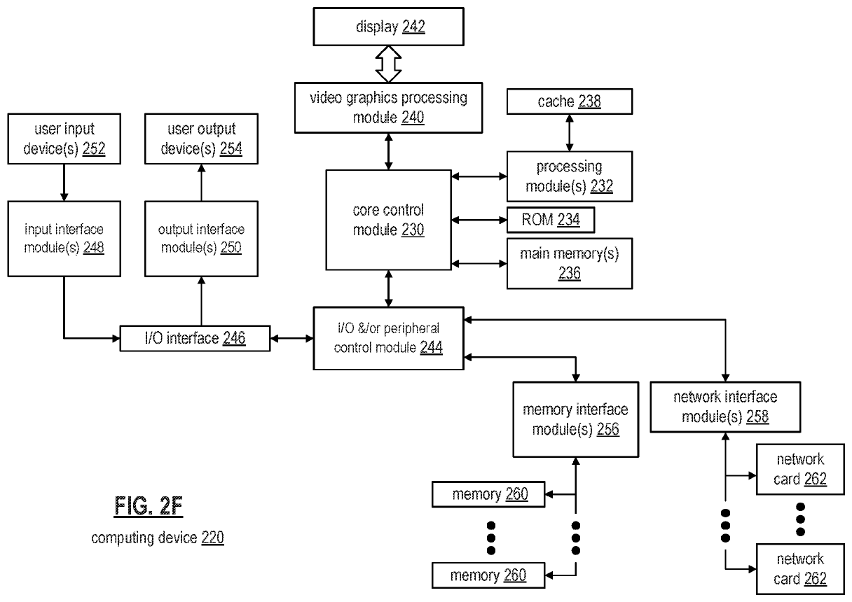

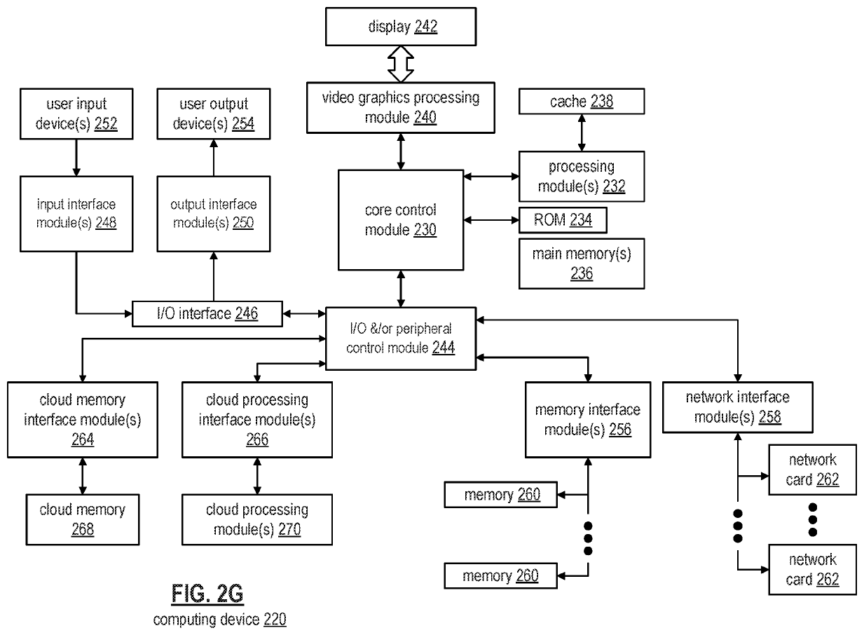

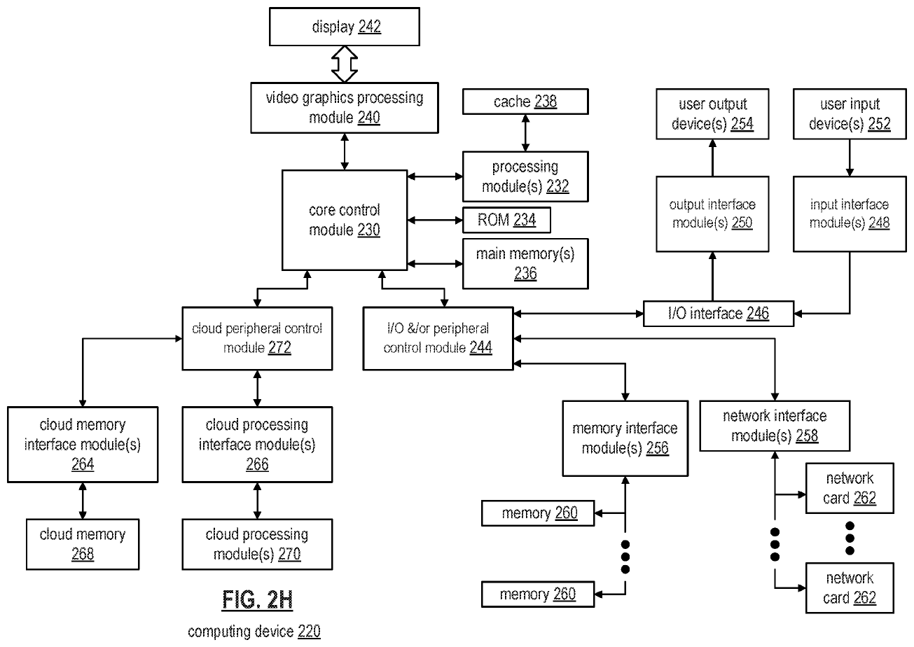

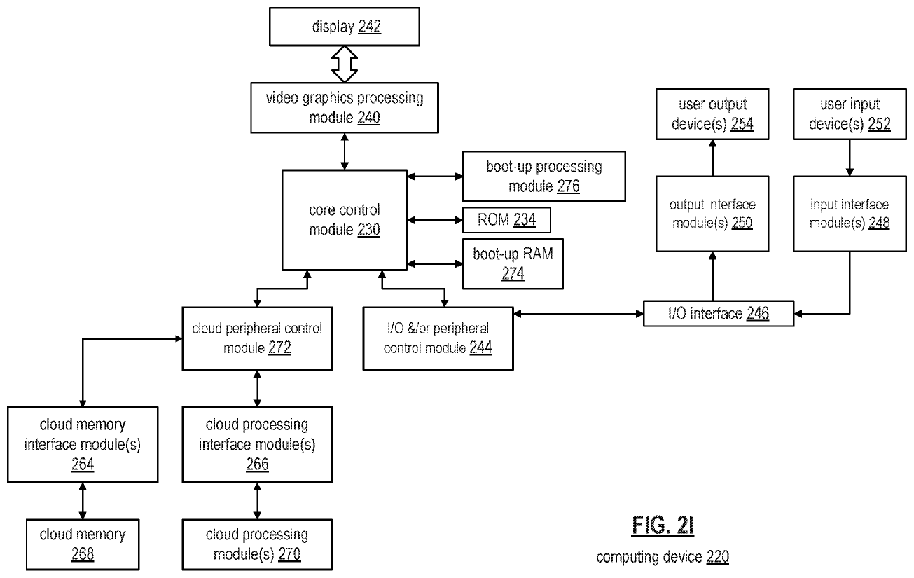

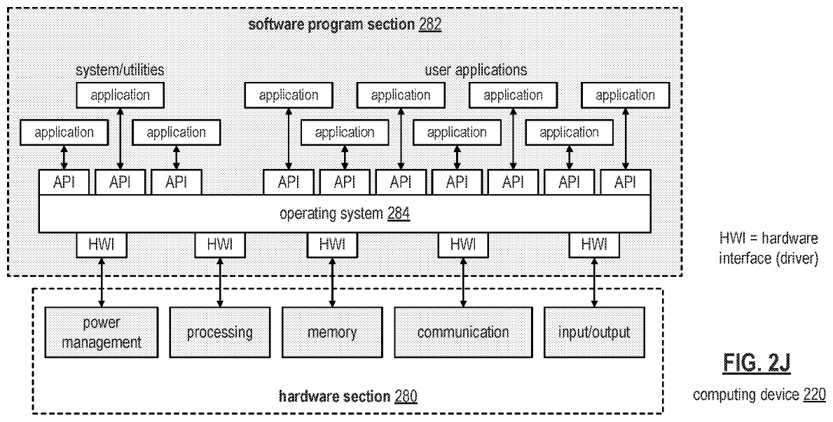

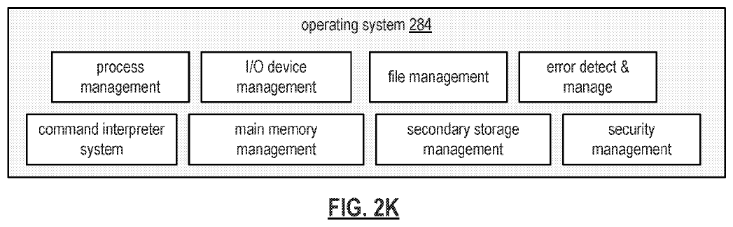

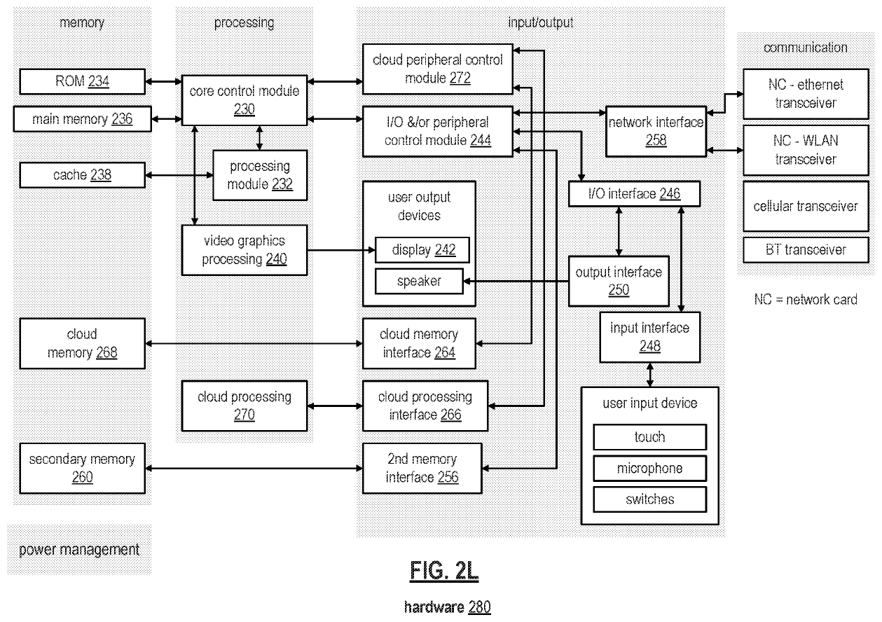

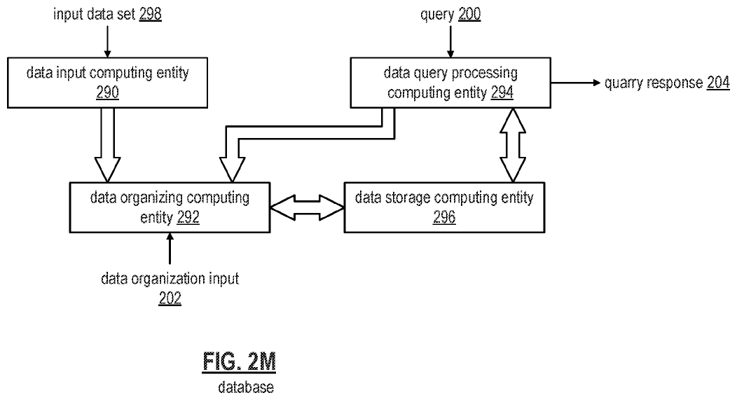

In addition to the specific examples of FIGS. 1B-1D, it should also be noted that the universal GUI library 100, application development platform 110, web platforms 115 and/or client device 125 can be implemented by or in conjunction with a computing entity 210. In this regard, FIGS. 2A through 2E are schematic block diagram of embodiments of such computing entities.

FIG. 2A is schematic block diagram of an embodiment of a computing entity 220 that includes a computing device 220 (e.g., one or more of the embodiments of FIGS. 2F-2L). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 220 that includes two or more computing devices 220 (e.g., two or more from any combination of the embodiments of FIGS. 2F-2L). The computing devices 220 perform the functions of a computing entity in a peer processing manner (e.g., coordinate together to perform the functions), in a master-slave manner (e.g., one computing device coordinates and the other support it), and/or in another manner.

FIG. 2C is schematic block diagram of an embodiment of a computing entity 220 that includes a network of computing devices 220 (e.g., two or more from any combination of the embodiments of FIGS. 2F-2L). The computing devices are coupled together via one or more network connections (e.g., WAN, LAN, cellular data, WLAN, etc.) and perform the functions of the computing entity.

FIG. 2D is schematic block diagram of an embodiment of a computing entity 220 that includes a primary computing device (e.g., any one of the computing devices of FIGS. 2F-2L), an interface device (e.g., a network connection), and a network of computing devices 220 (e.g., one or more from any combination of the embodiments of FIGS. 2F-2L). The primary computing device utilizes the other computing devices as co-processors to execute one or more the functions of the computing entity, as storage for data, for other data processing functions, and/or storage purposes.

FIG. 2E is schematic block diagram of an embodiment of a computing entity 220 that includes a primary computing device (e.g., any one of the computing devices of FIGS. 2F-2L), an interface device (e.g., a network connection) 222, and a network of computing resources 224 (e.g., two or more resources from any combination of the embodiments of FIGS. 2F-2L). The primary computing device utilizes the computing resources as co-processors to execute one or more the functions of the computing entity, as storage for data, for other data processing functions, and/or storage purposes.

FIGS. 2F-2L are schematic block diagram of embodiments of computing devices that form at least a portion of a computing entity. FIG. 2F is a schematic block diagram of an embodiment of a computing device 220 that includes a plurality of computing resources. The computing resources, which form a computing core, include one or more core control modules 230, one or more processing modules 232, one or more main memories 236, a read only memory (ROM) 234 for a boot up sequence, cache memory 238, one or more video graphics processing modules 240, one or more displays 242 (optional), an Input-Output (I/O) peripheral control module 244, an I/O interface module 246 (which could be omitted if direct connect IO is implemented), one or more input interface modules 248, one or more output interface modules 250, one or more network interface modules 258, and one or more memory interface modules 256.

A processing module 232 is described in greater detail at the end of the detailed description section and, in an alternative embodiment, has a direction connection to the main memory 236. In an alternate embodiment, the core control module 230 and the I/O and/or peripheral control module 244 are one module, such as a chipset, a quick path interconnect (QPI), and/or an ultra-path interconnect (UPI).

The processing module 232, the core module 230, and/or the video graphics processing module 240 form a processing core for the improved computer. Additional combinations of processing modules 232, core modules 230, and/or video graphics processing modules 240 form co-processors for the improved computer for technology. Computing resources 224 of FIG. 2E include one more of the components shown in this FIG. and/or in or more of FIGS. 2G through 2L.

Each of the main memories 236 includes one or more Random Access Memory (RAM) integrated circuits, or chips. In general, the main memory 236 stores data and operational instructions most relevant for the processing module 232. For example, the core control module 230 coordinates the transfer of data and/or operational instructions between the main memory 236 and the secondary memory device(s) 260. The data and/or operational instructions retrieved from secondary memory 260 are the data and/or operational instructions requested by the processing module or will most likely be needed by the processing module. When the processing module is done with the data and/or operational instructions in main memory, the core control module 230 coordinates sending updated data to the secondary memory 260 for storage.

The secondary memory 260 includes one or more hard drives, one or more solid state memory chips, and/or one or more other large capacity storage devices that, in comparison to cache memory and main memory devices, is/are relatively inexpensive with respect to cost per amount of data stored. The secondary memory 260 is coupled to the core control module 230 via the I/O and/or peripheral control module 244 and via one or more memory interface modules 256. In an embodiment, the I/O and/or peripheral control module 244 includes one or more Peripheral Component Interface (PCI) buses to which peripheral components connect to the core control module 230. A memory interface module 256 includes a software driver and a hardware connector for coupling a memory device to the I/O and/or peripheral control module 244. For example, a memory interface 256 is in accordance with a Serial Advanced Technology Attachment (SATA) port.

The core control module 230 coordinates data communications between the processing module(s) 232 and network(s) via the I/O and/or peripheral control module 244, the network interface module(s) 258, and one or more network cards 262. A network card 260 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 258 includes a software driver and a hardware connector for coupling the network card to the I/O and/or peripheral control module 244. For example, the network interface module 258 is in accordance with one or more versions of IEEE 802.11, cellular telephone protocols, 10/100/1000 Gigabit LAN protocols, etc.

The core control module 230 coordinates data communications between the processing module(s) 232 and input device(s) 252 via the input interface module(s) 248, the I/O interface 246, and the I/O and/or peripheral control module 244. An input device 252 includes a keypad, a keyboard, control switches, a touchpad, a microphone, a camera, etc. An input interface module 248 includes a software driver and a hardware connector for coupling an input device to the I/O and/or peripheral control module 244. In an embodiment, an input interface module 248 is in accordance with one or more Universal Serial Bus (USB) protocols.

The core control module 230 coordinates data communications between the processing module(s) 232 and output device(s) 254 via the output interface module(s) 250 and the I/O and/or peripheral control module 244. An output device 254 includes a speaker, auxiliary memory, headphones, etc. An output interface module 250 includes a software driver and a hardware connector for coupling an output device to the I/O and/or peripheral control module 244. In an embodiment, an output interface module 250 is in accordance with one or more audio codec protocols.

The processing module 232 communicates directly with a video graphics processing module 240 to display data on the display 242. The display 242 includes an LED (light emitting diode) display, an LCD (liquid crystal display), and/or other type of display technology. The display has a resolution, an aspect ratio, and other features that affect the quality of the display. The video graphics processing module 240 receives data from the processing module 232, processes the data to produce rendered data in accordance with the characteristics of the display, and provides the rendered data to the display 242.

FIG. 2G is a schematic block diagram of an embodiment of a computing device 220 that includes a plurality of computing resources similar to the computing resources of FIG. 2F with the addition of one or more cloud memory interface modules 264, one or more cloud processing interface modules 266, cloud memory 268, and one or more cloud processing modules 270. The cloud memory 268 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 270 is similar to processing module 232 but is remote from the core control module and is accessed via a network.

FIG. 2H is a schematic block diagram of an embodiment of a computing device 220 that includes a plurality of computing resources similar to the computing resources of FIG. 2G with a change in how the cloud memory interface module(s) 264 and the cloud processing interface module(s) 266 are coupled to the core control module 230. In this embodiment, the interface modules 264 and 266 are coupled to a cloud peripheral control module 272 that directly couples to the core control module 230.

FIG. 2I is a schematic block diagram of an embodiment of a computing device 220 that includes a plurality of computing resources, which includes include a core control module 230, a boot up processing module 276, boot up RAM 274, a read only memory (ROM) 234, a one or more video graphics processing modules 240, one or more displays 48 (optional), an Input-Output (I/O) peripheral control module 244, one or more input interface modules 248, one or more output interface modules 250, one or more cloud memory interface modules 264, one or more cloud processing interface modules 266, cloud memory 268, and cloud processing module(s) 270.

In this embodiment, the computing device 220 includes enough processing resources (e.g., module 276, ROM 234, and RAM 274) to boot up. Once booted up, the cloud memory 268 and the cloud processing module(s) 270 function as the computing device's memory (e.g., main and hard drive) and processing module.

FIG. 2J is a schematic block diagram of another embodiment of a computing device 220 that includes a hardware section 280 and a software program section 282. The hardware section 280 includes the hardware functions of power management, processing, memory, communications, and input/output. FIG. 2L illustrates the hardware section 280 in greater detail.

The software program section 282 includes an operating system 284, system and/or utilities applications, and user applications. The software program section further includes APIs and HWIs. APIs (application programming interface) are the interfaces between the system and/or utilities applications and the operating system and the interfaces between the user applications and the operating system 284. HWIs (hardware interface) are the interfaces between the hardware components and the operating system. For some hardware components, the HWI is a software driver. The functions of the operating system 284 are discussed in greater detail with reference to FIG. 2K.

FIG. 2K is a diagram of an example of the functions of the operating system of a computing device 220. In general, the operating system function to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 284 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc. ; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 2L is a schematic block diagram of the hardware components of the hardware section 280 of a computing device. The memory portion of the hardware section includes the ROM 234, the main memory 236, the cache memory 238, the cloud memory 268, and the secondary memory 260. The processing portion of the hardware section includes the core control module 230, the processing module 232, the video graphics processing module 240, and the cloud processing module 270.

The input/output portion of the hardware section includes the cloud peripheral control module 272, the I/O and/or peripheral control module 244, the network interface module 258, the I/O interface module 246, the output device interface 250, the input device interface 248, the cloud memory interface module 264, the cloud processing interface module 266, and the secondary memory interface module 256. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 2M is a schematic block diagram of an embodiment of a database that includes a data input computing entity 290, a data organizing computing entity 292, a data query processing computing entity 294, and a data storage computing entity 296. Each of the computing entities is an implementation in accordance with one or more of the embodiments of FIGS. 2A through 2E.

The data input computing entity 290 is operable to receive an input data set 298. The input data set 298 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 298 is in a desired tabular format, the data input computing entity 290 provides the data set to the data organizing computing entity 292. If not, the data input computing entity 290 reformats the data set to put it into the desired tabular format.

The data organizing computing entity 292 organizes the data set 298 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 294 receives a query 200, it accesses the data storage computing entity 296 regarding a data set for the query. If the data set is stored in a desired format for the query, the data query processing computing entity 294 retrieves the data set and executes the query to produce a query response 204. If the data set is not stored in the desired format, the data query processing computing entity 294 communicates with the data organizing computing entity 292, which re-organizes the data set into the desired format.

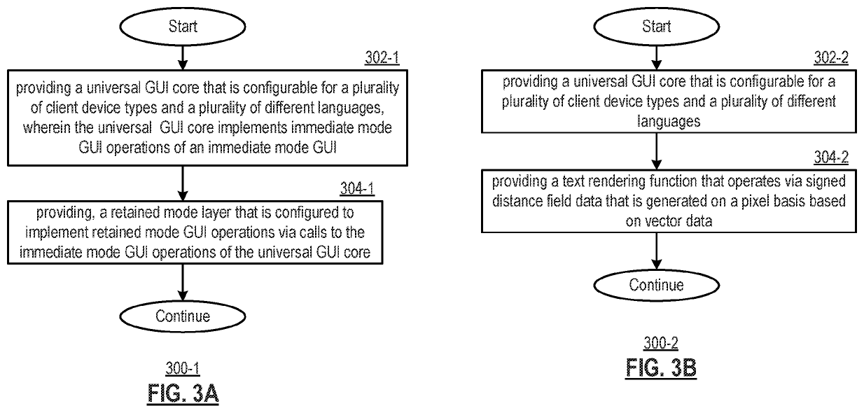

FIG. 3A presents a flowchart representation of an example method. In particular, a method 300-1 is presented for use, for example, with a universal graphical user interface (GUI) library and/or an application development platform having at least one processor and a non-transitory computer readable memory. Step 302-1 includes providing a universal GUI core that is configurable for a plurality of client device types and a plurality of different programming languages, wherein the universal GUI core implements immediate mode GUI operations of an immediate mode GUI. Step 304-1 includes providing, a retained mode layer that is configured to implement retained mode GUI operations via calls to the immediate mode GUI operations of the universal GUI core.

In addition or in the alternative to any of the foregoing, the universal GUI core and the retained mode layer each operate without dependency on another GUI library.

In addition or in the alternative to any of the foregoing, the method further includes providing a resource layer configured to load retained mode structure to the retained mode layer.

In addition or in the alternative to any of the foregoing, the resource layer, the universal GUI core and the retained mode layer each operate without dependency on any other GUI library.

In addition or in the alternative to any of the foregoing, the plurality of different device types include a plurality of mobile device types and a plurality of non-mobile device types.

In addition or in the alternative to any of the foregoing, the universal GUI core includes a layout function that stores a quality vector for each corresponding layout node of a plurality of layout nodes, the quality vector including binary bits that each correspond to one of a plurality of layout qualities and indicate whether or not the one of the plurality of layout qualities is specified for the corresponding layout node; wherein the layout function operates via a bitwise processing function to identify a proper subset of the plurality of layout qualities that is specified for the corresponding layout node.

In addition or in the alternative to any of the foregoing, the universal GUI core includes a text rendering function that operates via signed distance field data that is generated on a pixel basis based on vector data.

In addition or in the alternative to any of the foregoing, the universal GUI core includes a graphics rendering function that operates via signed distance field data that is not pre-computed and is generated via vector graphics data.

In addition or in the alternative to any of the foregoing, the method further includes providing a GUI transpiler configured to transpile universal GUI library code from a native coding language to an alternative coding language in response to selection of a corresponding one of the plurality of device types. In addition or in the alternative to any of the foregoing, the method further includes providing a GUI transpiler configured to transpile universal GUI library code from a native coding language to an alternative coding language in response to selection of a processing environment.

FIG. 3B presents a flowchart representation of an example method. In particular, a method 300-2 is presented for use, for example, in conjunction with a universal graphical user interface (GUI) library and/or an application development platform having at least one processor and a non-transitory computer readable memory. Step 302-2 providing a universal GUI core that is configurable for a plurality of client device types and a plurality of different programming languages. Step 304-2 includes providing a text rendering function that operates via signed distance field data that is generated on a pixel basis based on vector data.

In addition or in the alternative to any of the foregoing, the universal GUI core implements immediate mode GUI operations of an immediate mode GUI, and wherein the method further includes: providing a retained mode layer that is configured to implement retained mode GUI operations via calls to the immediate mode GUI operations of the universal GUI core.

In addition or in the alternative to any of the foregoing, the universal GUI core and the retained mode layer each operate without dependency on another GUI library.

In addition or in the alternative to any of the foregoing, the method further includes providing a resource layer configured to load retained mode structure to the retained mode layer.

In addition or in the alternative to any of the foregoing, the resource layer, the universal GUI core and the retained mode layer each operate without dependency on any other GUI library.

In addition or in the alternative to any of the foregoing, the plurality of different device types include a plurality of mobile device types and a plurality of non-mobile device types.

In addition or in the alternative to any of the foregoing, the universal GUI core includes a layout function that stores a quality vector for each corresponding layout node of a plurality of layout nodes, the quality vector including binary bits that each correspond to one of a plurality of layout qualities and indicate whether or not the one of the plurality of layout qualities is specified for the corresponding layout node; wherein the layout function operates via a bitwise processing function to identify a proper subset of the plurality of layout qualities that is specified for the corresponding layout node.

In addition or in the alternative to any of the foregoing, the universal GUI core includes a graphics rendering function that operates via signed distance field data that is not pre-computed and is generated via vector graphics data.

In addition or in the alternative to any of the foregoing, the method further includes providing a GUI transpiler configured to transpile universal GUI library code from a native coding language to an alternative coding language in response to selection of a corresponding one of the plurality of device types.

In addition or in the alternative to any of the foregoing, the method further includes providing a GUI transpiler configured to transpile universal GUI library code from a native coding language to an alternative coding language in response to selection of a processing environment.

As used herein the terms “tool” and “toolkit” correspond to a website, utility, platform, and/or software routine that performs one or more specific functions.

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the FIGs. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure., the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium or a non-transitory machine-readable storage medium.

While particular combinations of various functions and features of the one or more examples have been expressly described herein, other combinations of these features and functions are likewise possible. The present disclosure is not limited by the particular examples disclosed herein and expressly incorporates these other combinations.

1-40. (canceled)

41. A universal graphical user interface (GUI) library for use with an application development platform having at least one processor and a non-transitory computer readable memory, the universal GUI library comprising:
a universal GUI core that is configurable for a plurality of client device types and a plurality of different programming languages, wherein the universal GUI core implements immediate mode GUI operations of an immediate mode GUI; and
a retained mode layer that is configured to implement retained mode GUI operations via calls to the immediate mode GUI operations of the universal GUI core.

42. The universal GUI library of claim 41, wherein the universal GUI core and the retained mode layer each operate without dependency on another GUI library.

43. The universal GUI library of claim 41, further comprising:
a resource layer configured to load retained mode structure to the retained mode layer.

44. The universal GUI library of claim 43, wherein the resource layer, the universal GUI core and the retained mode layer each operate without dependency on any other GUI library.

45. The universal GUI library of claim 41, wherein the plurality of client device types include a plurality of mobile device types and a plurality of non-mobile device types.

46. The universal GUI library of claim 41, wherein the universal GUI core includes a layout function that stores a quality vector for each corresponding layout node of a plurality of layout nodes, the quality vector including binary bits that each correspond to one of a plurality of layout qualities and indicate whether or not the one of the plurality of layout qualities is specified for the corresponding layout node;
wherein the layout function operates via a bitwise processing function to identify a proper subset of the plurality of layout qualities that is specified for the corresponding layout node.

47. The universal GUI library of claim 41, wherein the universal GUI core includes a text rendering function that operates via signed distance field data that is generated on a pixel basis based on vector data.

48. The universal GUI library of claim 41, wherein the universal GUI core includes a graphics rendering function that operates via signed distance field data that is not pre-computed and is generated via vector graphics data.

49. The universal GUI library of claim 41, further comprising:
a GUI transpiler configured to transpile universal GUI library code from a native coding language to an alternative coding language in response to selection of a corresponding one of the plurality of client device types.

50. The universal GUI library of claim 41, further comprising:
a GUI transpiler configured to transpile universal GUI library code from a native coding language to an alternative coding language in response to selection of a processing environment.

51. A method for use with a universal graphical user interface (GUI) library of an application development platform having at least one processor and a non-transitory computer readable memory, the method comprising:
providing a universal GUI core that is configurable for a plurality of client device types and a plurality of different programming languages, wherein the universal GUI core implements immediate mode GUI operations of an immediate mode GUI; and
providing, a retained mode layer that is configured to implement retained mode GUI operations via calls to the immediate mode GUI operations of the universal GUI core.

52. The method of claim 51, wherein the universal GUI core and the retained mode layer each operate without dependency on another GUI library.

53. The method of claim 51, further comprising:
providing a resource layer configured to load retained mode structure to the retained mode layer.

54. The method of claim 53, wherein the resource layer, the universal GUI core and the retained mode layer each operate without dependency on any other GUI library.

55. The method of claim 51, wherein the plurality of client device types include a plurality of mobile device types and a plurality of non-mobile device types.

56. The method of claim 51, wherein the universal GUI core includes a layout function that stores a quality vector for each corresponding layout node of a plurality of layout nodes, the quality vector including binary bits that each correspond to one of a plurality of layout qualities and indicate whether or not the one of the plurality of layout qualities is specified for the corresponding layout node;
wherein the layout function operates via a bitwise processing function to identify a proper subset of the plurality of layout qualities that is specified for the corresponding layout node.

57. The method of claim 51, wherein the universal GUI core includes a text rendering function that operates via signed distance field data that is generated on a pixel basis based on vector data.

58. The method of claim 51, wherein the universal GUI core includes a graphics rendering function that operates via signed distance field data that is not pre-computed and is generated via vector graphics data.

59. The method of claim 51, further comprising:
providing a GUI transpiler configured to transpile universal GUI library code from a native coding language to an alternative coding language in response to selection of a corresponding one of the plurality of client device types.

60. The method of claim 51, further comprising:
providing a GUI transpiler configured to transpile universal GUI library code from a native coding language to an alternative coding language in response to selection of a processing environment.
